(19) United States
(12) Patent Application Publication
(10) Pub. No.: US 2009/0136053 A1
(43) Pub. Date: May 28, 2009

(54) NOISE CANCELLER, SOUND COLLECTOR HAVING THE NOISE CANCELLER, AND PORTABLE PHONE HAVING THE NOISE CANCELLER

(75) Inventor: Takashi Michiyoshi, Osaka (JP)

Correspondence Address: DICKSTEIN SHAPIRO LLP, 1825 EYE STREET NW, Washington, DC, 20006-5403, US

(73) Assignee: RICHO COMPANY, LTD., Tokyo (JP)

(21) Appl. No.: 12/064,718

(22) PCT Filed: Jul. 19, 2007
(86) PCT No.: PCT/JP2007/064626

§ 371 Date: Feb. 25, 2008

(30) Foreign Application Priority Data
Jul. 31, 2006 (JP) 2006-208084

(51) Int. Cl. G10K 11/16; H04M 1/00; H04B 15/00

(52) U.S. Cl. 381/71.1; 455/550.1; 381/94.1

(57) ABSTRACT

A noise canceller configured to remove surrounding noise from a desirable sound collected by a first microphone, the noise canceller includes a second microphone arranged in a place separated from the first microphone and configured to collect the surrounding noise; a second amplifier circuit part configured to amplify an output signal of the second microphone and output the output signal; and a signal processing circuit part configured to remove the surrounding noise from a sound collected by the first microphone by using the output signal of the second amplifier circuit part. The second amplifier circuit part is provided in the vicinity of the second microphone.

### TECHNICAL FIELD

The present invention generally relates to noise cancellers, sound collectors having the noise cancellers, and portable phones having the noise cancellers.

More specifically, the present invention relates to a noise canceller used for a sound collector or a portable phone and configured to remove surrounding noise from a desirable collected sound, a sound collector having the noise canceller, and a portable phone having the noise canceller.

### BACKGROUND ART

In a case where a call is made by using a portable phone, when the call is made in a place where noise such as a subway is large, surrounding noise is transferred to the recipient of the call so that it is difficult for the recipient to hear the sound.

Because of this, conventionally, may kinds of noise cancellers for cancelling the surrounding noise have been suggested.

In the noise canceller, a first microphone for collecting the voice sound of a talker and a second microphone for collecting surrounding noise are used. An electrical signal being output from the second microphone is subtracted from an electrical signal being output from the first microphone. See, for example, Japanese Laid-Open Patent Application Publication No. 9-331377 and Japanese Laid-Open Patent Application Publication No. 9-36763.

In addition, in order to remove the noise effectively, the arrangement of the first microphone and the second microphone is important. There have been a lot of suggestions about the arrangement of the first microphone and the second microphone. See, for example, International Publication WO2004/034734.

However, in the above-mentioned noise canceller, there is no consideration about electrical noise superposed on wiring from the first microphone or the second microphone to a sound processing circuit.

It is normal practice that the first microphone and the second microphone are arranged so as to be separated from each other. For example, while the first microphone is arranged in a place close to the mouth of the talker, the second microphone is frequently arrange near a receiver's speaker at a rear side of the first microphone. Under this arrangement, the distance between the first microphone and the second microphone is equal to or greater than 10 cm.

A single sound processing LSI configured to include the sound processing circuit is provided. In a case where the sound processing LSI is arranged in the vicinity of the first microphone, the distance between the second microphone and the sound processing LSI is long so that the electrical noise may be superposed on the wiring between the second microphone and the sound processing LSI.

In addition, in a case where an LCD display is arranged between the second microphone and the sound processing LSI, the wiring from the second microphone to the sound processing LSI passes the vicinity of a LCD drive clock signal. Accordingly, noise due to the drive clock signal is superposed on the electrical signal from the second microphone. Thus, if the electrical noise is contained in the electrical signal from the second microphone, it is not possible to effectively remove the noise.

### DISCLOSURE OF THE INVENTION

Accordingly, in a preferred embodiment of the present invention there is provided a novel and useful noise canceller, a sound collector having the noise canceller, and a portable phone having the noise canceller solving one or more of the problems discussed above.

More specifically, the embodiments of the present invention may provide a noise canceller whereby noise superposed on wiring from a microphone for collecting surrounding noise to a signal processing circuit is made small so that effective noise removal can be achieved, a sound collector having the noise canceller, and a portable phone having the noise canceller.

According to one aspect of the present invention there is provided a noise canceller configured to remove surrounding noise from a desirable sound collected by a first microphone, the noise canceller including:

a second microphone arranged in a place separated from the first microphone and configured to collect the surrounding noise;

a second amplifier circuit part configured to amplify an output signal of the second microphone and output the output signal; and

a signal processing circuit part configured to remove the surrounding noise from a sound collected by the first microphone by using the output signal of the second amplifier circuit part;

wherein the second amplifier circuit part is provided in the vicinity of the second microphone.

According to another aspect of the present invention there is provided a sound collector, including:

a noise canceller configured to remove surrounding noise from a desirable sound collected by a first microphone,

the noise canceller including

a second microphone arranged in a place separated from the first microphone and configured to collect the surrounding noise;

a second amplifier circuit part configured to amplify an output signal of the second microphone and output the output signal; and

a signal processing circuit part configured to remove the surrounding noise from a sound collected by the first microphone by using the output signal of the second amplifier circuit part;

wherein the second amplifier circuit part is provided in the vicinity of the second microphone.

According to other aspect of the present invention there is provided a portable phone, including:

a noise canceller configured to remove surrounding noise from a desirable sound collected by a first microphone,
the noise canceller including
a second microphone arranged in a place separated from the first microphone and configured to collect the surrounding noise;

a second amplifier circuit part configured to amplify an output signal of the second microphone and output the output signal; and

a signal processing circuit part configured to remove the surrounding noise from a sound collected by the first microphone by using the output signal of the second amplifier circuit part;

wherein the second amplifier circuit part is provided in the vicinity of the second microphone.

Other objects, features, and advantages of the present invention will become more apparent from the following detailed description when read in conjunction with the accompanying drawings.

### BRIEF DESCRIPTION OF THE DRAWINGS

FIG. 1 is a view showing a structural example of a sound collector having a noise canceller of an embodiment of the present invention;

FIG. 2 is a view showing an example where the sound collector shown in FIG. 1 is applied to a portable phone;

FIG. 3 is a block diagram showing an arrangement example of each of parts of the sound collector shown in FIG. 2;

FIG. 4 is a view showing another example where the sound collector shown in FIG. 1 is applied to the portable phone;

FIG. 5 is a view showing another example where the sound collector shown in FIG. 1 is applied to the portable phone; and

FIG. 6 is a view showing another example where the sound collector shown in FIG. 1 is applied to the portable phone.

### BEST MODE FOR CARRYING OUT THE INVENTION

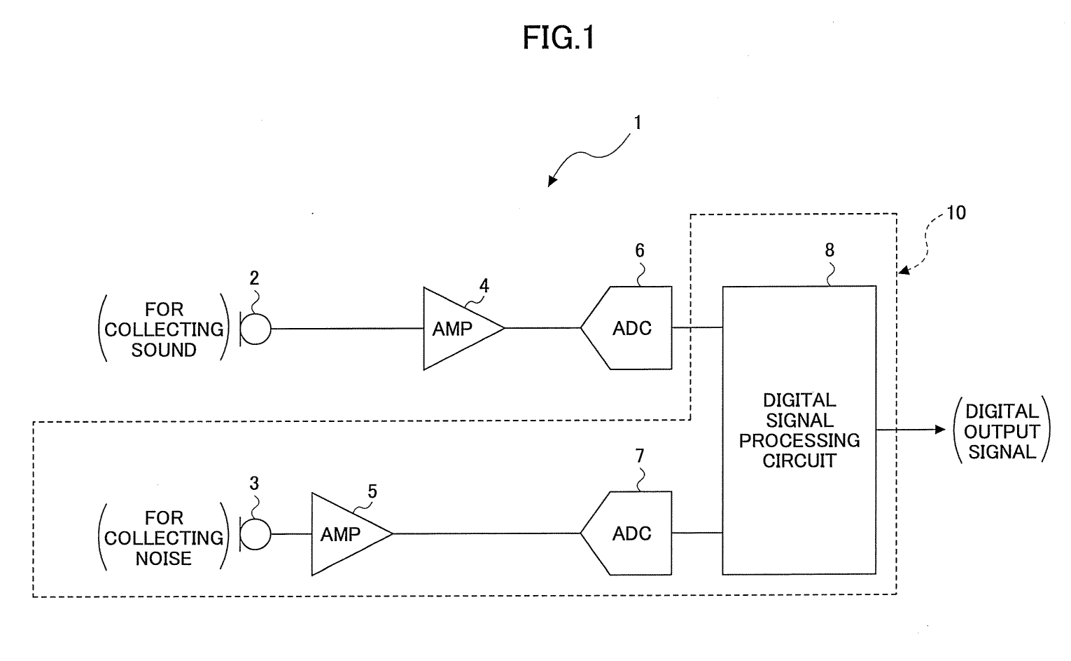

A description of the present invention and details of drawbacks of the related art are now given, with reference to FIG. 1 through FIG. 6, including embodiments of the present invention.

FIG. 1 is a view showing a structural example of a sound collector having a noise canceller of an embodiment of the present invention.

As shown in FIG. 1, a sound collector 1 includes a first microphone 2, a second microphone 3, a first amplifier circuit 4, a second amplifier circuit 5, a first A/D conversion circuit 6, a second A/D conversion circuit 7, and a digital signal processing circuit 8.

The first microphone 2 collects desirable sound. The second microphone 3 collects surrounding noise. The first amplifier circuit 4 amplifies an output signal of the first microphone 2. The second amplifier circuit 5 amplifies an output signal of the second microphone 3. The first A/D conversion circuit 6 A/D converts the output signal of the first amplifier circuit 4. The second A/D conversion circuit 7 A/D converts the output signal of the second amplifier circuit 5.

The second microphone 3, the second amplifier circuit 5, the second A/D conversion circuit 7, and the digital signal processing circuit 8 form a noise canceller 10.

The second amplifier circuit 5 is provided in the vicinity of the second microphone 3. The digital signal processing circuit 8 subtracts a digital signal input from the second A/D conversion circuit 7 from the digital signal input from the first A/D conversion circuit 6 so as to output the subtraction result.

As a result of this, the surrounding noise is removed from the sound collected by the first microphone 2.

The first amplifier circuit 4 works as a first amplifier circuit part and the second amplifier circuit 5 works as a second amplifier circuit part. The first A/D conversion circuit 6 works as a first A/D conversion circuit part and the second A/D conversion circuit 7 works as a second A/D conversion circuit part. The digital signal processing circuit 8 works as a signal processing circuit part.

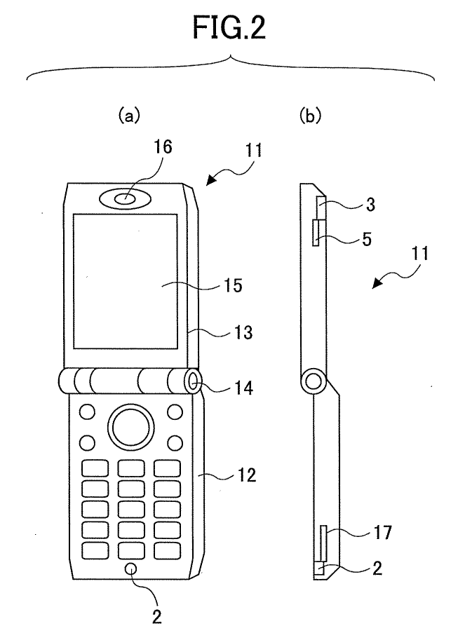

FIG. 2 is a view showing an example where the sound collector 1 shown in FIG. 1 is applied to a portable phone. More specifically, FIG. 2(a) shows external appearance of the portable phone seen from a front surface when the portable phone is being used. FIG. 2(b) is a side view of the portable phone and shows an example arrangement of each of the parts of the sound collector 1 shown in FIG. 1.

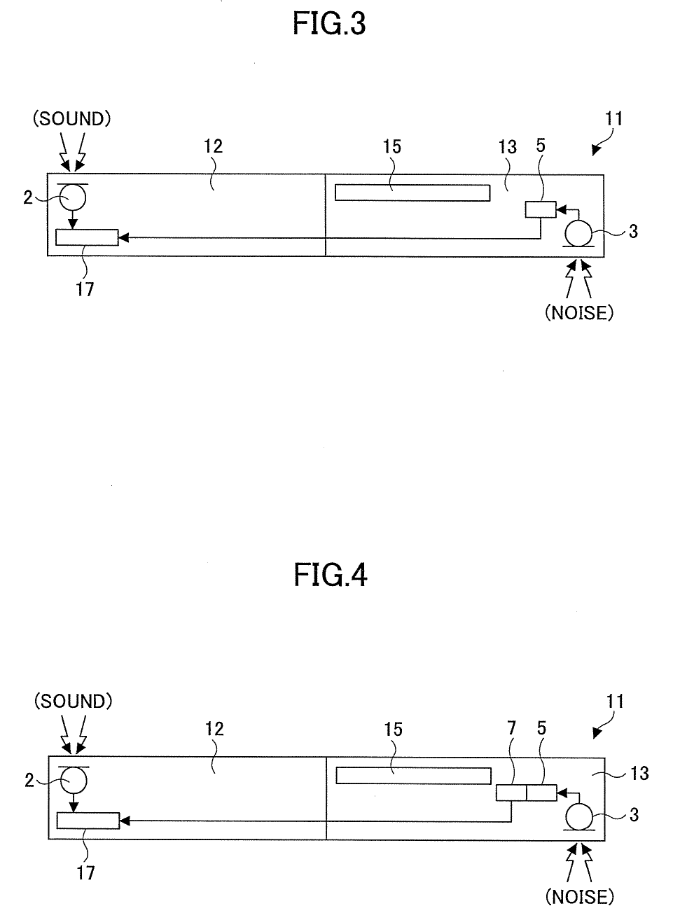

FIG. 3 is a block diagram showing an example arrangement of each of the parts of the sound collector 1 shown in FIG. 2.

As shown in FIG. 2, a portable phone 11 includes a first housing part 12, a second housing part 13, and a hinge part 14 connecting the first housing part 12 and the second housing part 13 to each other in a foldable manner. The first housing part 12 has an operations part such as ten keys. The second housing part 13 has an LCD display.

Furthermore, the first microphone 2 is arranged at a lower part of the first housing part 12, namely a lower part of the housing of the portable phone at the time of calling as shown in FIG. 2. A receiver's speaker 16 is arranged at an upper part of the second housing part 13, namely an upper part of the housing of the portable phone at the time of calling as shown in FIG. 2(a).

The second microphone 3 is provided at an upper part of the second housing 13, namely an upper outside part of the housing of the portable phone at the time of calling as shown in FIG. 2(b), on a surface opposite to the surface where the receiver's speaker 16 is arranged.

As shown in FIG. 2 and FIG. 3, the sound processing LSI 17 where the first amplifier circuit 4, the first A/D conversion circuit 6, the second A/D conversion circuit 7, and the digital signal processing circuit 8 are installed is arranged in the vicinity of the first microphone 2.

In addition, the second amplifier circuit 5 is arranged in the vicinity of the second microphone 3. The output signal of the second amplifier 5 is input to the second A/D conversion circuit in the sound processing LSI 17 via the wiring.

Thus, by arranging the sound processing LSI 17 in the vicinity of the first microphone 2, it is possible to shorten the wiring path from the first microphone 2 to the sound processing LSI 17 so that the electrical noise superposed on the wiring path can be made small.

In addition, since the second amplifier circuit 5 is arranged in the vicinity of the second microphone 3, the wiring path from the second microphone 3 to the second amplifier circuit 5 can be shortened so that the electrical noise superposed on the wiring path can be made small.

The output signal of the second amplifier circuit 5 is input to the sound processing LSI 17. The output signal of the second microphone 3 is amplified by the second amplifier circuit 5 and output impedance is decreased.

Therefore, the wiring from the second amplifier circuit 5 to the sound processing LSI 18 is long. Even if a noise source exists along the way of the wiring, the amount of the electrical noise superposed on the signal being output from the second amplifier circuit 5 can be made small.

Thus, since the noise signal collected by the second microphone 3 is input to the sound processing LSI 17 with high precision, it is possible to perform effective removal of the noise. In the cases of FIG. 2 and FIG. 3, the second amplifier circuit 5 may be included in a single IC.

On the other hand, while the second A/D conversion circuit 7 is installed in the sound processing LSI 17 in the examples shown in FIG. 2 and FIG. 3, the second A/D conversion circuit 7 may be arranged in the vicinity of the second amplifier circuit 5. In this case, a structure shown in FIG. 4 instead of the structure shown in FIG. 3 can be applied.

Here, FIG. 4 is a view showing another example where the sound collector shown in FIG. 1 is applied to the portable phone.

Under the structure shown in FIG. 4, the output signal of the second amplifier circuit 5 is converted to a digital signal and input to the digital signal processing circuit 8 in the sound processing LSI 17 arranged in a separate position via the wiring. Therefore, it is possible to further reduce the noise superposed on the wiring.

In the example shown in FIG. 4, the second amplifier circuit 5 and the second A/D conversion circuit may be included in a single IC. In addition, a MEMS microphone module may be used where the A/D conversion circuit is installed instead of the second microphone 3, the second amplifier circuit 5, and the second A/D conversion circuit 7.

While the first amplifier circuit 4 is installed in the sound processing LSI 17 in the examples shown in FIG. 2 through FIG. 4, the first amplifier circuit 4 may be arranged in the vicinity of the first microphone 2 outside the sound processing LSI 17 and the sound processing LSI 17 may be arranged in a position separated from the first microphone 2. In this case, a structure shown in FIG. 5 instead of the structure shown in FIG. 4 can be applied.

Here, FIG. 5 is a view showing another example where the sound collector shown in FIG. 1 is applied to the portable phone.

Under the structure shown in FIG. 5, it is possible to achieve the same effect as that of the case of FIG. 4 and the degree of freedom on the arrangement of the sound processing LSI 17 is large. Therefore, it is possible to reduce the limitations of design for an apparatus, such as a portable phone, using the sound collector 1. In the example shown in FIG. 5, the first amplifier circuit 4 may be included in a single IC.

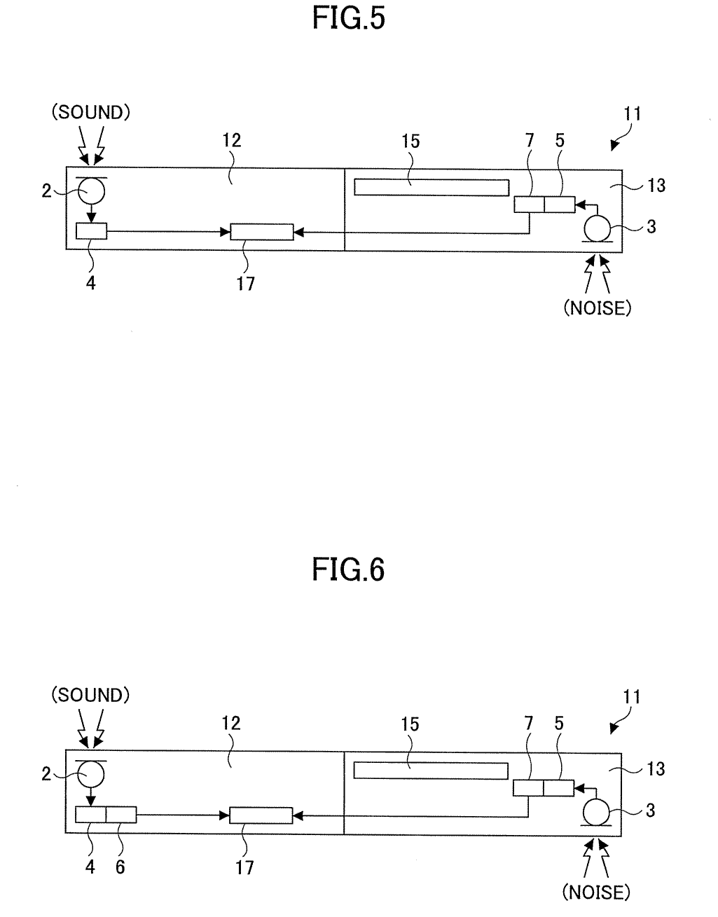

Furthermore, while the first A/D conversion circuit 6 is installed in the sound processing LSI 17 in the example shown in FIG. 5, the first A/D conversion circuit 6 may be arranged in the vicinity of the first amplifier circuit 4. In this case, a structure shown in FIG. 6 instead of the structure shown in FIG. 5 can be applied.

Here, FIG. 6 is a view showing another example where the sound collector shown in FIG. 1 is applied to the portable phone.

Under the structure shown in FIG. 6, the output signal of the first amplifier circuit 4 is converted to a digital signal and input to the digital signal processing circuit 8 in the sound processing LSI 17 arranged in a separate position via the wiring. Therefore, it is possible to further reduce the noise superposed on the wiring.

In the example shown in FIG. 6, the first amplifier circuit 4 and the first A/D conversion circuit 6 may be included in a single IC.

In addition, a MEMS microphone module may be used where the A/D conversion circuit is installed instead of the first microphone 2, the first amplifier circuit 4, and the first A/D conversion circuit 6. Furthermore, the MEMS microphone module may be used where the A/D conversion circuit is installed instead of the second microphone 3, the second amplifier circuit 5, and the second A/D conversion circuit 7.

Thus, in the noise canceller of the embodiment of the present invention, the second amplifier circuit 5 is arranged in the vicinity of the second microphone 3. Here, the second amplifier circuit 5 amplifies the output signal of the second microphone 3. The second microphone 3 collects the surrounding noise and is arranged in a position separated from the first microphone 2 configured to collect the desirable sound.

Thus, it is possible to obtain the noise signal collected by the second microphone 3 with high precision. Therefore, it is possible to effectively remove the surrounding noise from the sound collected by the first microphone 2.

According to the above-discussed embodiment of the present invention, it is possible to provide a noise canceller configured to remove surrounding noise from a desirable sound collected by a first microphone, the noise canceller including: a second microphone arranged in a place separated from the first microphone and configured to collect the surrounding noise; a second amplifier circuit part configured to amplify an output signal of the second microphone and output the output signal; and a signal processing circuit part configured to remove the surrounding noise from a sound collected by the first microphone by using the output signal of the second amplifier circuit part; wherein the second amplifier circuit part is provided in the vicinity of the second microphone.

The noise canceller may further include a second A/D conversion circuit part configured to A/D convert the output signal of the second amplifier circuit part and output the output signal, wherein the second A/D conversion circuit part may be provided in the vicinity of the second amplifier circuit part. The signal processing circuit part may subtract the output signal of the second A/D conversion circuit part from a signal formed by amplifying the output signal of the first microphone signal and A/D converting the output signal, so that the surrounding noise is removed from a sound collected by the first microphone. The signal processing circuit part may be included in a single IC and the second amplifying circuit part is included in another IC. The second amplifier circuit part and the second A/D conversion circuit part may be included in a single IC and the signal processing circuit part is included in another IC.

According to the above-discussed embodiment of the present invention, it is possible to provide a sound collector, including a noise canceller configured to remove surrounding noise from a desirable sound collected by a first microphone, the noise canceller including a second microphone arranged in a place separated from the first microphone and configured to collect the surrounding noise; a second amplifier circuit part configured to amplify an output signal of the second microphone and output the output signal; and a signal processing circuit part configured to remove the surrounding noise from a sound collected by the first microphone by using the output signal of the second amplifier circuit part; wherein the second amplifier circuit part is provided in the vicinity of the second microphone.

The noise canceller may further include a second A/D conversion circuit part configured to A/D convert the output signal of the second amplifier circuit part and output the output signal; and the second A/D conversion circuit part is provided in the vicinity of the second amplifier circuit part. The sound collector may further include a first amplifier circuit part configured to amplify an output signal of the first microphone and output the output signal; and a first A/D conversion circuit part configured to A/D convert the output signal of the first amplifier circuit part and output the output signal; wherein the first amplifier circuit part may be provided in the vicinity of the first microphone. The first A/D conversion circuit part may be provided in the vicinity of the first amplifier circuit part. The signal processing circuit part may subtract the output signal of the second A/D conversion circuit part from the output signal of the first A/D conversion circuit part, so that the surrounding noise is removed from a sound collected by the first microphone. The signal processing circuit part may be included in a single IC and the second amplifier circuit part may be included in another IC. The second amplifier circuit part and the second A/D conversion circuit part may be included in a single IC and the signal processing circuit part is included in another IC. The first amplifier circuit part may be included in a single IC. The first amplifier circuit part and the first A/D conversion circuit part may be included in a single IC.

According to the above-discussed embodiment of the present invention, it is possible to provide a portable phone, including: a noise canceller configured to remove surrounding noise from a desirable sound collected by a first microphone, the noise canceller including a second microphone arranged in a place separated from the first microphone and configured to collect the surrounding noise; a second amplifier circuit part configured to amplify an output signal of the second microphone and output the output signal; and a signal processing circuit part configured to remove the surrounding noise from a sound collected by the first microphone by using the output signal of the second amplifier circuit part; wherein the second amplifier circuit part is provided in the vicinity of the second microphone.

The noise canceller further may include a second A/D conversion circuit part configured to A/D convert the output signal of the second amplifier circuit part and output the output signal; and the second A/D conversion circuit part is provided in the vicinity of the second amplifier circuit part. The portable phone may further include a first amplifier circuit part configured to amplify an output signal of the first microphone and output the output signal; and a first A/D conversion circuit part configured to A/D convert the output signal of the first amplifier circuit part and output the output signal; wherein the first amplifier circuit part may be provided in the vicinity of the first microphone. The first A/D conversion circuit part may be provided in the vicinity of the first amplifier circuit part. The signal processing circuit part may subtract the output signal of the second A/D conversion circuit part from the output signal of the first A/D conversion circuit part, so that the surrounding noise is removed from a sound collected by the first microphone. The second microphone may be provided at an outside of an upper part of a housing of the portable phone. The signal processing circuit part may be included in a single IC and the second amplifier circuit part is included in another IC. The second amplifier circuit part and the second A/D conversion circuit part may be included in a single IC and the signal processing circuit part is included in another IC. The first amplifier circuit part may be included in a single IC. The first amplifier circuit part and the first A/D conversion circuit part may be included in a single IC.

Thus, according to the noise canceller, the sound collector having the noise canceller, and the portable phone having the noise canceller, the second amplifier circuit part amplifies the output signal of the second microphone, the second microphone being arranged in a place separated from the first microphone and configured to collect surrounding noise, and outputs the output signal. Such a second amplifier circuit part is arranged in the vicinity of the second microphone.

Hence, it is possible to make the noise superposed on the wiring from the microphone collecting the surrounding noise to the signal processing circuit small and thereby effective removing of the noise can be accomplished.

In addition, the second A/D conversion circuit part, configured to A/D convert the output signal of the second amplifier circuit part and output the output signal, is provided in the vicinity of the second amplifier circuit part.

Hence, it is possible to make the noise superposed on the wiring to the signal processing circuit smaller; and thereby more effective removing of the noise can be accomplished and a noise removal ratio can be improved.

Furthermore, in the sound collector having the above-discussed noise canceller and the portable phone having the above-discussed noise canceller, the first amplifier circuit part configured to amplify the output signal of the first microphone is provided in the vicinity of the first microphone, or the first A/D conversion circuit part configured to A/D convert the output signal of the first amplifier circuit part is provided in the vicinity of the first amplifier circuit part.

Therefore, the degree of freedom of arrangement of the LSI including the signal processing circuit part is large so that the degree of freedom for the design of an apparatus, such as a portable phone, having the noise canceller can be high.

The present invention is not limited to the above-discussed embodiments, but variations and modifications may be made without departing from the scope of the present invention.

This patent application is based on Japanese Priority Patent Application No. 2006-208084 filed on Jul. 31, 2006, the entire contents of which are hereby incorporated by reference.

1. A noise canceller configured to remove surrounding noise from a desirable sound collected by a first microphone, the noise canceller comprising:
a second microphone arranged in a place separated from the first microphone and configured to collect the surrounding noise;
a second amplifier circuit part configured to amplify an output signal of the second microphone and output the output signal; and
a signal processing circuit part configured to remove the surrounding noise from a sound collected by the first microphone by using the output signal of the second amplifier circuit part;
wherein the second amplifier circuit part is provided in the vicinity of the second microphone.

2. The noise canceller as claimed in claim 1, further comprising:
a second A/D conversion circuit part configured to A/D convert the output signal of the second amplifier circuit part and output the output signal,
wherein the second A/D conversion circuit part is provided in the vicinity of the second amplifier circuit part.

3. The noise canceller as claimed in claim 2, wherein the signal processing circuit part subtracts the output signal of the second A/D conversion circuit part from a signal formed by amplifying the output signal of the first microphone signal and A/D converting the output signal, so that the surrounding noise is removed from a sound collected by the first microphone.

4. The noise canceller as claimed in claim 1, wherein the signal processing circuit part is included in a single IC and the second amplifying circuit part is included in another IC.

5. The noise canceller as claimed in claim 2, wherein the second amplifier circuit part and the second A/D conversion circuit part are included in a single IC and the signal processing circuit part is included in another IC.

6. A sound collector, comprising:
a noise canceller configured to remove surrounding noise from a desirable sound collected by a first microphone,
the noise canceller including
a second microphone arranged in a place separated from the first microphone and configured to collect the surrounding noise;
a second amplifier circuit part configured to amplify an output signal of the second microphone and output the output signal; and
a signal processing circuit part configured to remove the surrounding noise from a sound collected by the first microphone by using the output signal of the second amplifier circuit part;
wherein the second amplifier circuit part is provided in the vicinity of the second microphone.

7. The sound collector as claimed in claim 6, wherein the noise canceller further includes a second A/D conversion circuit part configured to A/D convert the output signal of the second amplifier circuit part and output the output signal; and
the second A/D conversion circuit part is provided in the vicinity of the second amplifier circuit part.

8. The sound collector as claimed in claim 7, further comprising:
a first amplifier circuit part configured to amplify an output signal of the first microphone and output the output signal; and
a first A/D conversion circuit part configured to A/D convert the output signal of the first amplifier circuit part and output the output signal;
wherein the first amplifier circuit part is provided in the vicinity of the first microphone.

9. The sound collector as claimed in claim 8, wherein the first A/D conversion circuit part is provided in the vicinity of the first amplifier circuit part.

10. The sound collector as claimed in claim 8, wherein the signal processing circuit part subtracts the output signal of the second A/D conversion circuit part from the output signal of the first A/D conversion circuit part, so that the surrounding noise is removed from a sound collected by the first microphone.

11. The sound collector as claimed in claim 6, wherein the signal processing circuit part is included in a single IC and the second amplifier circuit part is included in another IC.

12. The sound collector as claimed in claim 7, wherein the second amplifier circuit part and the second A/D conversion circuit part are included in a single IC and the signal processing circuit part is included in another IC.

13. The sound collector as claimed in claim 8, wherein the first amplifier circuit part is included in a single IC.

14. The sound collector as claimed in claim 9, wherein the first amplifier circuit part and the first A/D conversion circuit part are included in a single IC.

15. A portable phone, comprising:
a noise canceller configured to remove surrounding noise from a desirable sound collected by a first microphone,
the noise canceller including
a second microphone arranged in a place separated from the first microphone and configured to collect the surrounding noise;
a second amplifier circuit part configured to amplify an output signal of the second microphone and output the output signal; and
a signal processing circuit part configured to remove the surrounding noise from a sound collected by the first microphone by using the output signal of the second amplifier circuit part;
wherein the second amplifier circuit part is provided in the vicinity of the second microphone.

16. The portable phone as claimed in claim 15, wherein the noise canceller further includes a second A/D conversion circuit part configured to A/D convert the output signal of the second amplifier circuit part and output the output signal; and
the second A/D conversion circuit part is provided in the vicinity of the second amplifier circuit part.

17. The portable phone as claimed in claim 16 further comprising:
a first amplifier circuit part configured to amplify an output signal of the first microphone and output the output signal; and
a first A/D conversion circuit part configured to A/D convert the output signal of the first amplifier circuit part and output the output signal;
wherein the first amplifier circuit part is provided in the vicinity of the first microphone.

18. The portable phone as claimed in claim 17, wherein the first A/D conversion circuit part is provided in the vicinity of the first amplifier circuit part.

19. The portable phone as claimed in claim 17, wherein the signal processing circuit part subtracts the output signal of the second A/D conversion circuit part from the output signal of the first A/D conversion circuit part, so that the surrounding noise is removed from a sound collected by the first microphone.

20.-24. (canceled)
